(19) United States
(12) Patent Application Publication
(10) Pub. No.: US 2009/0084456 A1
(43) Pub. Date: Apr. 2, 2009

(54) FITTING WITH INTEGRAL TEST MEMBRANE

(75) Inventor: James Mantyla, Barrie (CA)

Correspondence Address: HOFFMANN & BARON, LLP, 6900 JERICHO TURNPIKE, SYOSSET, NY, 11791, US

(73) Assignee: CANPLAS INDUSTRIES LTD., Barrie (CA)

(21) Appl. No.: 11/955,550

(22) Filed: Dec. 13, 2007

(30) Foreign Application Priority Data
Sep. 27, 2007 (CA) 2604601

(51) Int. Cl. F16L 55/00; B32B 37/00; B32B 38/10; B32B 37/06

(52) U.S. Cl. 138/90; 156/293; 156/256; 156/73.1; 138/89

(57) ABSTRACT

There is disclosed a fitting for a plumbing drainage system. The fitting comprises a body, an inlet at one end of the body, an outlet at the other end of the body, a fluid flow passageway extending between the inlet and the outlet through the body. The fitting also comprises a hydraulic test membrane bonded to the fitting across the fluid passageway, the membrane being sized and shaped to be manually punctured. There is also disclosed a method of making such a fitting.

### FIELD OF THE INVENTION

The present invention pertains to the general field of plumbing products. More particularly, the present invention relates to plumbing products that are used for hydraulic testing of plumbing installations in buildings.

### BACKGROUND OF THE INVENTION

When building construction takes place, building codes mandate that the plumbing drainage system be installed and then hydraulically tested before being approved by a building inspector. This testing is typically conducted during the construction phase, before the walls are completed and thus take place at a time when the plumbing system is readily accessible at all points. What is desired of course is to ensue that once the walls are finished that the system does not leak into the building.

One of the most common ways to test the plumbing system is to seal it at or near its lowest point, as well as at those intermediate height locations where the drainage system connects to fixtures (i.e. toilets, bathtubs, sinks, etc.). The piping system is then filled with water and left to stand for a predetermined period. The plumbing system must then hold that water, without draining, for the code-specified period of time. The inspector will monitor the water level in the system to ensure that there are no leaks. Once the water test has been passed, the water is drained from the system and the interior walls of the building can be finished.

Typically, the drainage system includes a line clean-out tee installed at or near its lowest point, at the base of the main plumbing drainage stack, just above where the stack goes under the basement or slab floor and connects to a run out to the municipal sewer system. This provides a convenient indoor access to the clean out tee so that it can be used in the event of a blockage occurring in the run out to the city sewers.

The clean-out tee typically has a threaded, removable access cover and may have dimensions of 3″×3″×3″, 4″×4″×4″, or 4″×3″×4″ (hub×clean-out×hub). The clean-out tee allows for access to the drainage system for clearing of obstructions in the drainage system that may arise from time to time during the life of the building. However, because it provides access to the inside of the drainage pipe, it is also used as a location to seal the plumbing system to conduct the initial hydraulic testing of the plumbing system.

One known way of sealing the drainage system at the clean-out tee involves inserting a mechanical plug into the clean-out tee through the access opening and placing the plug into the pipe at the inlet of the clean-out tee. The plug is then made to expand either by inflating a rubber “test ball” which subsequently seals against the interior walls of the pipe, or by tightening a wing nut which forces a rubber ring to expand against the inside walls of the pipe. After the test is completed, the mechanical plug is removed, allowing the water to drain.

One problem with sealing the drainage system with such mechanical plugs is that they are expensive and require the plumber to carry them in his or her truck as a tool. Moreover, since one size does not fit all clean-out tees, the plumber must carry a range of sizes to ensure that the correct sized plug for the particular pipe being tested is at hand. When using the inflatable ball method, there is a further problem that the rubber, which deteriorates and cracks with age, may burst while being inflated, or even worse, during the course of the hydraulic testing.

Other problems involve dropping the plug down the pipe, where it can create a permanent blockage, and the uncontrolled release of water from the test, which makes removing the plug without dropping it more difficult.

Several attempts have been made at overcoming some of the disadvantages of the mechanical plug sealing systems, most of which have been directed to improvements in “test plates”. A test plate is a separate element that must be inserted into the tee at the job site. Typically, the test plate is located in, or near, the inlet of a clean-out tee prior to plumbing the clean-out tee into the drainage system.

Examples of some prior test plates are disclosed in U.S. Pat. Nos. 4,739,799 (Carney et al.), 4,763,510 (Palmer), and 6,182,704 (Bevacco). U.S. Pat. No. 6,595,242 to Duncan discloses a tear-out coupling for installation on a pipe end, which has a unitary removable barrier connected to a pulling tab to facilitate in its removal. Similar devices are also disclosed in U.S. Pat. Nos. 4,602,504 (Barber). U.S. Pat. Nos. 6,622,748, 6,755,215, and 6,915,819 to Duncan disclose a tear-out coupling for installation between two pipe ends. The tear-out coupling has a planar disk which is designed so that the pressure head created by the water line will cause it to rupture when punctured. Rupturing of the planar disk is accomplished by creating a puncture through the planar disk using a mechanism comprising a puncturing device, located on the planar disk, which is mechanically linked by wire to a plunger operable by the plumber. Once the planar disk is ruptured the puncturing mechanism is removed through a wye or tee pipe which must be formed in one of the connected pipes.

U.S. Pat. No. 6,588,454 to Johnson et al. discloses a specialized plumbing system test fitting, the sole purpose of which, is to conduct the hydraulic leak test. The Johnson et al. device contains a diaphragm assembly positioned in a counter bore of the test fitting. The diaphragm assembly has a rim part, which is dimensioned to fit snugly within the counter bore, and contains a relatively rupturable diaphragm part. However, a special pull member is required to tear the diaphragm away from the rim part. U.S. Pat. No. 4,602,504 (Huber) discloses a test plate in the form of a gasket which is compressed between two connecting pipes, and which has a center shut off baffle removable by pulling on a pull cord connected thereto.

However, all of the above prior test plate sealing systems prove to be problematic in one way or another. For example, installing and hydraulically sealing a test plate to the inlet of a clean-out tee prior to its installation adds an additional step for the plumber to carry out in the field.

Furthermore, once installed, the test plate is often difficult to remove after the test is completed, as it must first be broken and then any remaining shards must be removed. Typically, test plates require a tool, such as plyers, hammer, screw or the like, to be driven into the test plate to manually break it out of the pipe, in order to drain water from the system, once the hydraulic testing is completed. Often, remnants of the test plate are left in the pipe forming an obstruction on which debris gets snagged and begins to accumulate leading to a blockage down the road. There is also the risk that some of the broken pieces of the test plate may go down the pipe lodging further down the line and may cause a blockage some time later.

U.S. Pat. Nos. 6,390,118 and 6,564,823 to Mankins disclose tools directed to the problem of removing remnants of the test plate so as to reduce the likelihood of an obstruction. These special reaming tools are for penetrating and reaming out a test cap, of the type which is installed in the field on a section of pipe connected to the sewer line before it is connected to a clean-out branch. However, the specialized tool is expensive and a plumber would need to have at hand several sizes to ensure the correct sized tool is available for a particular pipe. Furthermore, there is still the risk that some of the broken pieces of the test plate may go down the pipe lodging further down the line and causing a blockage.

A particular problem with the prior art sealing systems is that their removal often proves to be a messy ordeal since the water drains quickly and suddenly as the mechanical plug, or test plate, is being removed. Even though the plumbing system is not operational during the course of the hydraulic testing, from time to time human waste is placed into the sealed systems, which fouls the test water. Since the mechanical seal is located at the lowest point of the sealed system, as soon as the plug is removed, or the test plate broken open, the water rushes down fiercely, often splashing the plumber. This common occurrence is quite unpleasant and unsanitary.

What is desired is a simple and inexpensive device which may be installed in conjunction with a plumbing drainage system serving the dual purpose of providing an access point and a means for conducting the hydraulic test. Moreover, once the hydraulic test is passed, the device should provide a means to sanitarily drain the test water and ready the system for operation without the need for further expense.

### SUMMARY OF THE INVENTION

The present invention is directed to a simple and yet effective device, in the form of a fitting, for example a test tee clean out fitting, closet flange or pipe, which is useful for conducting a hydraulic test of a freshly installed plumbing drainage system of a building. The present invention provides an inexpensive test membrane which is installed in the factory and which therefore saves labour costs on the building site during installation and use. The present invention also provides a membrane which is thin and so saves on material, but which is strong enough to withstand the normal range of pressures required for a pressure test plate. The present invention is further easily ruptured in a controlled way to permit a controlled release of the hydraulic test water which is safer, more sanitary and easier than certain prior art devices. The material for the membrane is made compatible with its use and most preferably can be sonic welded and is not affected by typical plastic pipe solvent.

Therefore, according to one aspect of the present invention, there is provided a test tee clean out fitting for a plumbing drainage system, said fitting comprising:
a body;
an inlet at one end of the body;
an outlet at the other end of the body;
a fluid flow passageway extending between the inlet and the outlet through said body; and
a hydraulic test membrane bonded to said fitting across said fluid passageway, said membrane being sized and shaped to be manually punctured.

According to another aspect, the hydraulic test membrane may be integrally formed of a uniform thickness.

According to yet another aspect, the hydraulic test member may be transparent.

According to yet another aspect, the fitting includes an inwardly directed shoulder between said inlet and said access opening, said shoulder having an upstream face, and wherein said hydraulic test membrane is bonded to said upstream face. The upstream face may be generally perpendicular to said fluid passageway and forms a bonding ring for said membrane about a periphery of said membrane. Furthermore, the membrane may be flexible, and held in place by being bonded to the bonding ring.

According to a further aspect, the present invention provides a method of making a test tee clean out fitting for a plumbing drainage system comprising the step of bonding a membrane into said tee to form a watertight load supporting barrier across said tee before said fitting is send to a building site.

### BRIEF DESCRIPTION OF THE DRAWINGS

Reference will now be made, by way of example only, to drawings illustrating the preferred embodiments of the invention, in which:

FIG. 1 is a side view of a test tee clean-out fitting having a body and a hydraulic test membrane sonically welded thereto according to the present invention with a pipe inserted into its outlet and another pipe being inserted into its inlet;

FIG. 2 is a cross-sectional view of the fitting of FIG. 1 taken along line 2-2;

FIG. 3 is a side view of a membrane assembly station having a base, a positioning puck and a sonic welding head, with the body and membrane of FIG. 2 being placed into position in the assembly station for assembly, the body and membrane being shown in a cross-sectional view;

FIG. 4 is a cross-sectional view of the body of FIG. 3 taken along line 4-4;

FIG. 5 is a perspective view of the fitting of FIG. 1;

FIG. 6 is a cross-sectional view of a closet flange fitting having a body and a hydraulic test membrane bonded thereto according to the present invention;

FIG. 7 is a cross-sectional view of a pipe fitting having a body and a hydraulic test membrane bonded thereto according to the present invention;

FIG. 8 is a cross-sectional view showing the pipe fitting of FIG. 7, and a cover being inserted into a regular tee clean-out fitting; and

FIG. 9 is a cross-sectional view of FIG. 8 with the pipe fitting and cover attached to the regular tee clean-out fitting.

### DETAILED DESCRIPTION OF THE PREFERRED EMBODIMENTS

The present invention is described in more detail with reference to exemplary embodiments thereof as shown in the appended drawings. While the present invention is described below including preferred embodiments, it should be understood that the present invention is not limited thereto. Those of ordinary skill in the art having access to the teachings herein will recognize additional implementations, modifications, and embodiments which are within the scope of the present invention as disclosed and claimed herein. In the figures, like elements are given like reference numbers. For the purposes of clarity, not every component is labelled in every figure, nor is every component of each embodiment of the invention shown where illustration is not necessary to allow those of ordinary skill in the art to understand the invention. It should also be born in mind that the figures are not necessarily drawn to scale as the concepts disclosed herein are not limited to any particular dimensions.

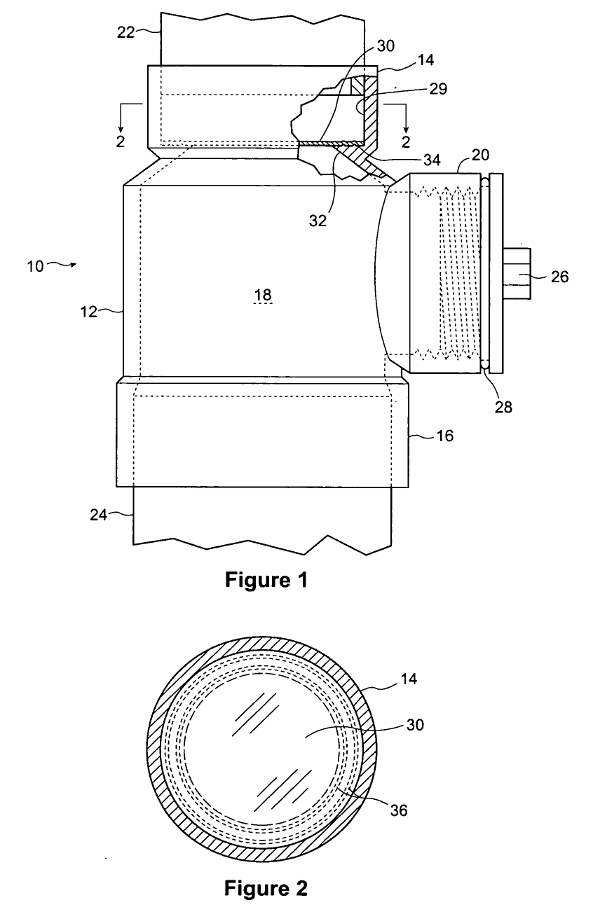

Referring now to FIGS. 1 and 2, a test tee clean-out fitting according to an embodiment of the present invention is shown generally indicated by numeral 10. The test tee clean-out fitting 10 has a body 12 which is sized and shaped like a conventional 4″×3″×4″ clean-out tee. The body 12 has an inlet 14 at one end, an outlet 16 at the other end, and a fluid flow passageway 18 extending through the body 12 between the inlet 14 and the outlet 16. An access opening 20 is provided on the body 12 to the fluid passageway 18.

As will be understood by those skilled in the art, the inlet 14 is adapted to couple to interior plumbing pipes 22, and the outlet 16 is adapted to couple to a sewer line 24. The access opening 20 is sized and shaped to permit a plumper to access the passageway 18 with his or her hand. Accordingly, the inlet 14, access opening 20, and outlet 16 will preferably have standard diameters of 3 or 4 inches.

The access opening 20 is covered by a removable cover 26 securable thereto. The cover 26 may be removably secured to the access opening 20 by any conventional means. A preferred means is to provide threads on the periphery of the cover 26 or the access opening 20 and complementary grooves on the other of the cover 26 and the access opening 20 so that the cover 26 may be securely screwed to the access opening 20. In order to help provide a watertight seal, a gasket 28 may be provided between the cover 26 and the access opening 20.

As best seen in FIG. 2, a hydraulic test membrane 30 is bonded to an inner wall 29 of the body 12 of the fitting 10 across the fluid passageway 18 so as to form a watertight load supporting barrier between the inlet 14 and the access opening 20.

As best seen in FIG. 1 the inner wall 29 of the body 12 preferably includes an inwardly directed shoulder 32 with an upstream face 34 positioned between the inlet 14 and the access opening 20. The figures show the upstream face 34 as being generally perpendicular to the fluid flow passageway 18. However, it will be appreciated that the angle of the upstream face 34 with respect to the fluid passageway 18 may depart from perpendicular. In other embodiments the inner wall 29 may lack the shoulder 32, as long as the hydraulic test membrane 30 is still bonded to the inner wall 29. While all these alternate embodiments are contemplated by the present invention, as described in more detail below, for reliable and consistent bonding results during the manufacture of the fitting 10, it is preferable for the fitting to be provided with the shoulder 32, and for the hydraulic test membrane to be held in place by being bonded about its periphery to the upstream face 34 thereof. What is important is that the hydraulic test membrane 30 is bonded to the inner wall 29 of the body 12 in a watertight, load supporting manner, about a periphery of the hydraulic test membrane 30.

As used herein, the term “bonded” is used to mean to be securely connected together, and includes connections by means of adhesives, as well as integrally formed connections formed by means of chemical processes, heat staking, heat fusion, sonic welding, one-piece molding, or the like. Sonic welding however, is the preferred means of achieving the bond, and is described in more detail below.

The hydraulic test membrane 30 is preferably integrally formed from a flexible plastic such as PVC, and is of a uniform thickness. However, it is also contemplated that the membrane may be formed from an appropriate plastic resin or even metallic foil. The most preferred form of the membrane is a thin, non self-supporting, flexible membrane. In this sense, non self-supporting means that the membrane droops under its own weight when supported at one end only. More specifically, non self-supporting means that but for being bonded to the fitting about the periphery of the hydraulic test membrane 30, the membrane 30 would be unable to support the hydraulic load. Preferably the plastic hydraulic test membrane 30 has a thickness of between about 0.015 inches to 0.040 inches. Most preferably the plastic hydraulic test membrane 30 has a thickness of about 0.020 inches. If metallic foil is used for the hydraulic test membrane, the preferred thickness is between 0.005 to 0.020 inches. While these are preferred values, the present invention comprehends all combinations of membrane thicknesses and material compositions which are non self-supporting.

As discussed in more detail below, the preferred method of manufacturing the fitting 10, involves sonic welding of the hydraulic test membrane 30 to the upstream face 34. In order to ensure that a seal between the upstream face 34 and the hydraulic test membrane 30 is reliably formed about the periphery of the hydraulic test membrane 30, during the one-step sonic welding step of the manufacturing process, it is preferable to use at least one bonding ring 36. More preferably, at least two such bonding rings 36 are employed to ensure a leak-proof seal is made. As shown in FIGS. 1, 2 and 5, two bonding rings 36 between the upstream face 34 and hydraulic test membrane 30 are visible in the finished fitting 10 around the full periphery of the hydraulic test membrane 30. Although such bonding rings 36 are preferred, the present invention comprehends a liquid tight seal arising from bonding the hydraulic test membrane 30 directly to the inner wall 29, or the shoulder 32 of the inner wall 29, all of which are considered to be parts of the inner wall of the fitting 10 according to the present invention. For example, if the bond is achieved by means of adhesives or chemical processes then there may not be a need for such bonding rings 36 to obtain reliable results. Furthermore, there may not be a need for such bonding rings 36 if the manufacturing process involves heat staking or pressing and fusing the periphery of the hydraulic test membrane 30 partially into the upstream face 34. In such cases, what will be visible in the finished fitting 10 is a depressed point contact (not shown) along the periphery of the hydraulic test membrane 30 where the bonding device contacts the membrane 30 and urges it into the upstream face 34.

In the preferred form of the present invention, where the bonding or sealing occurs by sonic welding, it will be appreciated by those skilled in the art that there are several ways to effect the bond, all of which are comprehended within the broad scope of the invention. For example, the additional plastic which is fused to form the bond may be initially formed as part of the hydraulic test membrane 30, a separate ring, or as ribs formed in the molded plastic fitting 10, or the upstream face 34. The present invention also comprehends the use of raised ridges on the sonic welding head 38 to ensure a liquid-tight bond around the periphery of the hydraulic test membrane.

Thus, while the preferred fitting 10 will have an ABS plastic body 12 with two bonding rings 36, integral to the upstream face 34, bonded to the flexible plastic PVC hydraulic test membrane 30 by means of sonic welding, many other configurations of seal are comprehended as will be appreciated by those skilled in the art. Furthermore, certain combinations of materials used for the body 12 and the hydraulic test membrane 30 may necessitate specific types of bonding materials and bonding means, discussed below. All such alternate embodiments are contemplated by the present invention.

It can now be understood that such a fitting 10 may be coupled between the interior plumbing pipes 22 and the sewer line 24 at the lowest point of the system, to permit a plumber to conduct a hydraulic leak test on the interior plumbing pipes 22.

Accordingly, the hydraulic test membrane 30, and the bond between the hydraulic test membrane 30 and the body 12, must be strong enough to withstand the pressures involved during a standard hydraulic leak test of about 15 psi. What is important is that the hydraulic test membrane 30 will remain bonded to the body 12, in a watertight manner, during the duration of the hydraulic leak testing.

Furthermore, in order to permit the controllable release the test water from the interior plumbing pipes 22, and allow it to drain through the outlet 16 into the sewer line 24 once testing is completed, the hydraulic test membrane 30 must be sized and shaped to permit manual puncture by a pointed implement, such as a knife or a screw driver, from the access opening 20. Once punctured according to the present invention the bond between the hydraulic test membrane 30 and the body 12 is strong enough for the punctured membrane to remain in place, without being carried off down the drain. In the unlikely event that some of the punctured membrane is carried of, it is thin enough so as to be unlikely to cause any kind of a blockage of the drain or sewer line 24.

Thus it may now be understood that the hydraulic test membrane 30 must remain bonded to the body 12 of the fitting 10 in a watertight manner during the hydraulic leak testing, and once testing is completed the plumber will be able to puncture in the hydraulic test membrane 30 with a pointed implement to make a limited hole to controllably release the test water from the interior plumbing pipes 22, and allow it to drain through the outlet 16 into the sewer line 24.

As can be appreciated the hydraulic test membrane 30 of the present invention would not, on its own, be self-supporting across the body 12 of the fitting 10 and is completely held in position by means of the bond. Therefore, the bond performs two functions, it supports the hydraulic test membrane 30 across the fluid flow passageway 18, and it seals the hydraulic test membrane 30 to the inner wall 29 of the body 12 of the fitting 10. A continuous bond about the periphery of the hydraulic test membrane 30 is therefore preferred to ensure that the joint between the hydraulic test membrane 30 and the body 12 is watertight even against the pressure head created during hydraulic testing. The preferred bond can hold a water head of two stories at least 15 and most preferable at least 20 feet.

The present invention comprehends that the hydraulic test membrane 30 is bonded to the inner wall 29 of the body 12 of the fitting 10 in a manufacturing step, before the finished fitting 10 is shipped to the plumber. This is easily accomplished by means of a heat staking, heat fusion, sonic welding or adhesive bonding step in manufacturing, and can be easily automated. Good results have been obtained by the following manufacturing steps. First the body 12 of the fitting 10 is formed by plastic injection molding, in a known manner. The body 12 includes the inner wall 29 including the inwardly directed shoulder 32 having the upstream face 34 as described above. The molded body 12 is allowed to cool so it is set.

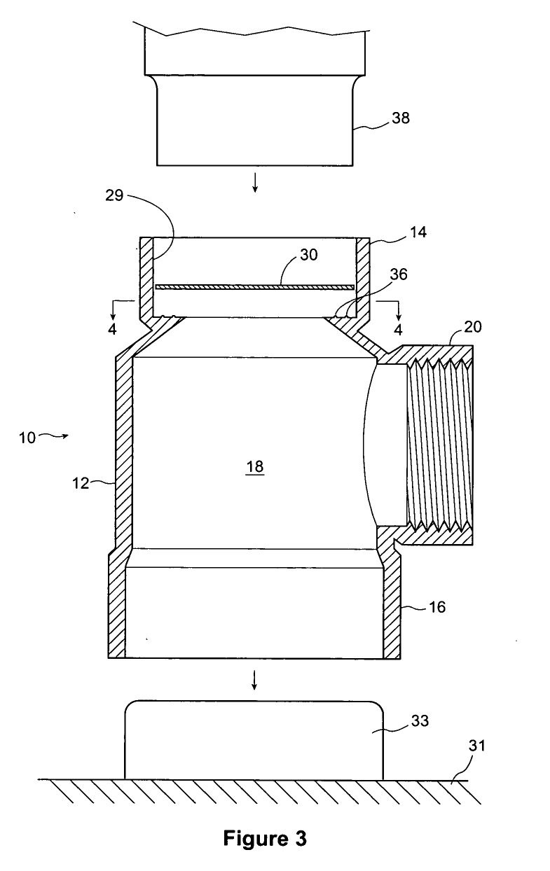

Then the molded body 12 is taken to the membrane assembly station, which is illustrated in FIG. 3. A circular section of membrane is cut for insertion into the body 12. The hydraulic test membrane is cut in the shape of a circle which is sized and shaped to fit onto the upstream face 34 of the shoulder 32. Preferably the membrane assembly station has a base 31 with an attached positioning puck 33. The positioning puck 33 is sized and shaped to allow the outlet 16 of the body 12 to slide over it. The purpose of the base 31 and positioning puck 33 is to align the body 12 with a sonic welding head 38, which is arranged above the positioning puck 33, so that when the welding head 38 is lowered into the inlet 14, it will press the hydraulic test membrane 30 flat against the upstream face 34.

Thus, as shown in FIG. 3, the body 12 of the fitting 10 is placed over the positioning puck 33 on the base 31, and the hydraulic test membrane 30 is inserted into the inlet 14 to rest on the upstream face 34 of the shoulder 32. The sonic welding head 38 is then lowered into the body 12 and is used to heat and fuse the hydraulic test membrane 30 to the upstream face 34 of the shoulder 32 so as to form the watertight and load bearing bond described above. Then the bond is allowed to cool and the finished test tee clean out fitting 10, shown in FIG. 5 is made ready for shipping.

As can be appreciated, to ensure the formation of the watertight and load bearing bond between the hydraulic test membrane 30 and the body 12, during the above described sonic welding manufacturing step, the welding head 38 must be oriented so that it will contact the membrane 30 and press it flat against the upstream face 34 of the shoulder 32. If the welding head 38 or body 12 are misaligned or tilted by even a small degree, the welding process may result in the formation of discontinuities or areas of weakness in the bond. Such discontinuities or areas of weakness in the bond are unacceptable as the resulting test tee clean out fitting 10 will leak and the membrane 30 may completely or partially detach from the body 12, when the fitting 10 is subjected to hydraulic testing during use. However, it has been found that including at least one bonding ring 36 on the upstream face 34 of the shoulder 32, compensates for slight misalignments between the sonic welding head 38 and the upstream face 34.

As will be appreciated, when the sonic welding head 38 is misaligned with respect to the upstream face 34, as it is urged onto the hydraulic test membrane 30, which is positioned therebetween, only a portion of the welding surface of the sonic welding head 38 will make contact with the hydraulic test membrane 30. The sonic welding head 38, being at an angle with respect to the upstream face 34, will leave a gap at the opposite portion of the welding surface between the upstream face 34 and the hydraulic test membrane 30. As can be imagined this would result in a weak bond subject to premature dissociation of the membrane 30 from the fitting, or leaks, during hydraulic testing.

However, by providing at least one bonding ring 36 between the hydraulic test membrane 30 and the upstream face 34, as the welding surface of the sonic welding head 38 contacts and bonds the hydraulic test membrane 30 to the bonding ring 36, the bonding ring 36 will become reduced in height along the contacted portion allowing the sonic welding head 38 to be urged further toward the upstream face 34 along the contacted portion. This in turn will allow the opposite portion of the welding surface to contact the hydraulic test membrane 30 and move it closer toward the upstream face 34, reducing and eliminating the gap, so that the hydraulic test membrane 30 contacts the bonding ring 36, and becomes bonded thereto, all along its periphery.

As a result, the number of defective fittings 10, in which a weak or discontinuous bond is formed during the welding step is reduced or eliminated.

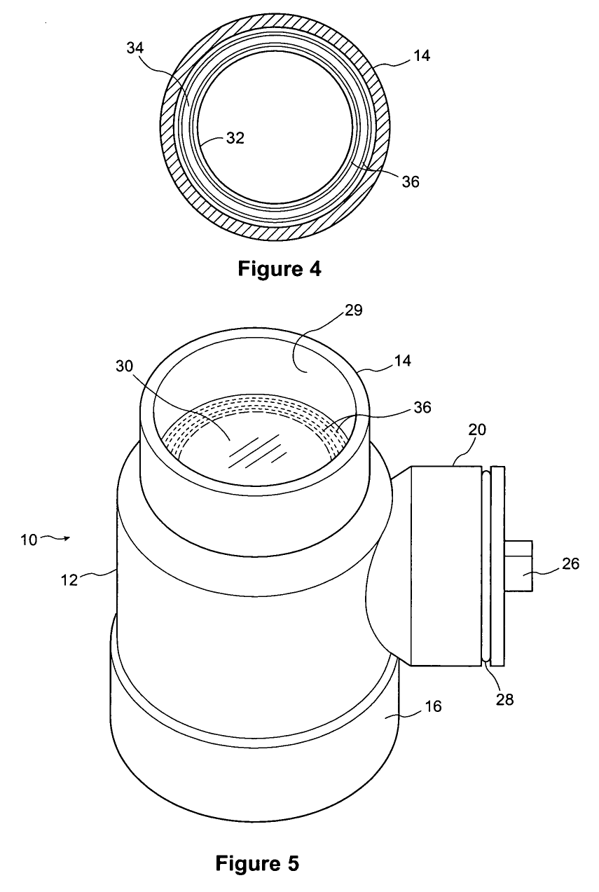

Preferably, two bonding rings 36, sized and shaped to ensure a liquid-tight seal are integrally molded into the upstream face 34 of the body 12 at the time of its manufacture, as shown in FIGS. 3 and 4. In the figures, the two bonding rings 36 are shown as continuous concentric raised ridges having a wider base and a tapered upper portion. During the sonic welding step, the bonding rings 36 will be bonded to the hydraulic test membrane 30. Although two such bonding rings 36 are illustrated in the figures as being integral to the upstream face 34, it is also contemplated that more or fewer bonding rings 36 may be provided on the upstream face. Alternately, one or more bonding rings may be formed integrally on the periphery of the hydraulic test membrane 30, in which case, the sonic welding step will bond the bonding ring 36 of the hydraulic test membrane 30 to the upstream face 34. Furthermore, it is contemplated that at least one bonding ring 36 is integrally formed on both the upstream face 34 and on the periphery of the hydraulic test membrane 30, prior to the welding step. Further still, it is also contemplated that the bonding ring 36 is a separate ring member (not shown) which is positioned between the upstream face 34 and the hydraulic test membrane 30 and bonded to both during the sonic welding step. Moreover, in other embodiments of the present invention the bonding rings 36 may be discontinuous (not shown) about the upstream face 34 and/or the hydraulic test membrane 30, provided that a liquid-tight seal exists in total.

However, as mentioned above it is also contemplated that other embodiments will not have any such bonding rings 36, in which case the hydraulic test membrane 30 will be bonded directly to the inner wall 29, or the shoulder 32 of the inner wall 29. For example, if the bond is achieved by means of adhesives or chemical processes then there may not be a need for such bonding rings 36 to obtain reliable results. Furthermore, there may not be a need for such bonding rings 36 if the manufacturing process involves heat staking or pressing and fusing the periphery of the hydraulic test membrane 30 partially into the upstream face 34.

Thus, while the preferred way of manufacturing the fitting 10 is to mold an ABS plastic body 12 with two bonding rings 36, integral to the upstream face 34, and bonding thereto a flexible plastic PVC hydraulic test membrane 30 by means of sonic welding, many other ways of manufacturing the fitting 10 are contemplated. Furthermore, certain combinations of materials used for the body 12 and the hydraulic test membrane 30 may necessitate specific types of bonding methods and materials, which will be appreciated by those skilled in the art. All such alternate bonding methods are contemplated by the present invention.

It can now be appreciated that the above described manufacturing step, being automated and occurring in the manufacturing plant, reduces the amount of work in the field for the installer, such as a plumber.

To achieve good results, it is preferred to use a material for the membrane 30 which can be sonically fused to the body 12 of the fitting 10. For example, where the body 12 is made from ABS the membrane 30 is preferred to be made from PVC, as this forms a good bond. If the materials do not permit the use of a sonic weld, then other forms of connection, such as heat staking could be used. Solvent welding is less preferred for the reason set out below.

It can now be appreciated that the load bearing strength of the bond permits the hydraulic test membrane 30 to be constructed of thinner, less expensive and less problematic materials than previously possible with prior art devices. Furthermore, the shoulder 32 serves as a pipe stop, to prevent inadvertently damaging the hydraulic test membrane 30 when connecting an interior plumbing pipe 22 to the inlet 14 during installation. Due to the thin nature of the membrane 30 of the present invention, the hydraulic test membrane 30 does not interfere in anyway with the connection of the fitting 10 to a pipe section, which can simply seat up against the pipe stop in a normal manner. Thus, even though the present invention comprehends having a built-in test membrane 30 in the body 12 of the fitting 10 in the unassembled state, the presence of the hydraulic test membrane 30 does not alter or affect the ability to use and connect the fitting 10 to the plumbing system in the field in a conventional manner.

Typically the pipe 22, 24 will be connected to the test tee clean out fitting 10 in the field by means of solvent welding. The solvent should not be applied in an amount sufficient to reach the hydraulic test membrane 30 of the present invention, but it is understood that the hydraulic test membrane 30 is located directly below the solvent welded joint between the pipe and the fitting 10. For this reason it is possible that extra solvent might be present and might drip down onto the hydraulic test membrane 30. For this reason, it is preferred if the hydraulic test membrane 30 is formed from a material which is not affected by the typical solvent used in pipe welds of this type. For this reason, a thin, non-self supporting, flexible thermoplastic membrane (e.g. PVC) or metallic foil is preferred for the hydraulic test membrane 30.

In use, the plumber simply installs the fitting 10 between the interior plumbing pipe 22 and the sewer line 24 at a convenient lower point of the drainage system and conducts the hydraulic tests. As can now be appreciated, the plumber does not need to carry, store or install any separate hydraulic sealing structures, since the fitting 10 already includes the hydraulic test membrane 30 bonded thereto between the inlet 14 and the access opening 20.

Once the hydraulic testing is successfully completed the plumber punctures the hydraulic test membrane 30 with a knife, for example, through the access opening 20 and allows the test water to controllably drain through a hole in the membrane into the sewer line 24. With the test water completely drained, the plumber then uses a knife, or the like, to cut out the test membrane 30 from the fitting 10 by severing it entirely about its periphery. The plumber will be able to do so by reaching into the fitting through the access opening 20. The plumber can then remove the cut-out hydraulic test membrane 30 through the access opening 20. Finally, the plumber readies the drainage system for use by securing the cover 26 to the access opening 20. It will be appreciated that the bonded periphery will not release, even after the hydraulic test membrane 30 is cut from the fitting 10. Thus, there will remain attached to the rim a ring of the membrane which is permanently bonded thereto.

Conveniently, the hydraulic test membrane 30 may be made of a transparent material, to permit a plumber to see if anything fell into the system prior to removing the membrane 30. If the plumber notices a large piece of debris, or a tool, resting on the inlet side of the test membrane 30, he will be more careful when removing the test membrane, to ensure that the debris or tool is not accidentally dropped into the sewer line, and the consequent risk of an obstruction, can be prevented.

While reference has been made to various preferred embodiments of the invention other variations are comprehended by the broad scope of the appended claims. Some of these have been discussed in detail in this specification and others will be apparent to those skilled in the art. All such variations and alterations are comprehended by this specification are intended to be covered, without limitation.

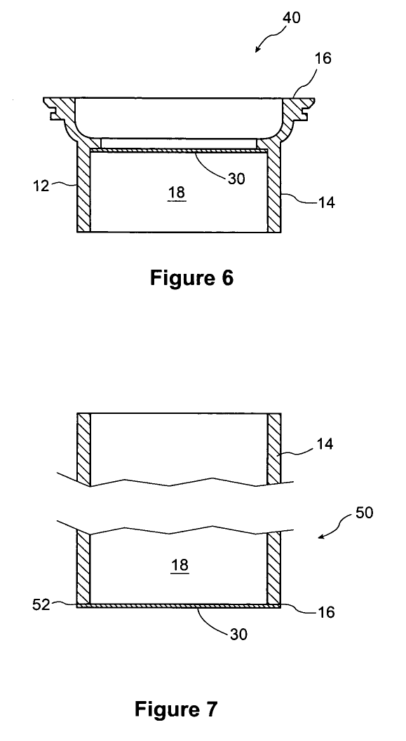

For example, another embodiment of the present invention, shown in FIG. 6, is a closet flange 40 in which the hydraulic test membrane 30 is bonded within the fitting across the fluid flow passageway 18, between the inlet 14 and the outlet 16. As will be appreciated, such a closet flange 40 is adapted to couple to interior plumbing pipes. Prior to connecting a toilet bowl (not shown) to the closet flange 40, the hydraulic leak test may be performed. Following a successful leak test, the hydraulic test membrane 30 may be manually punctured and removed from the closet flange and the toilet bowl installed.

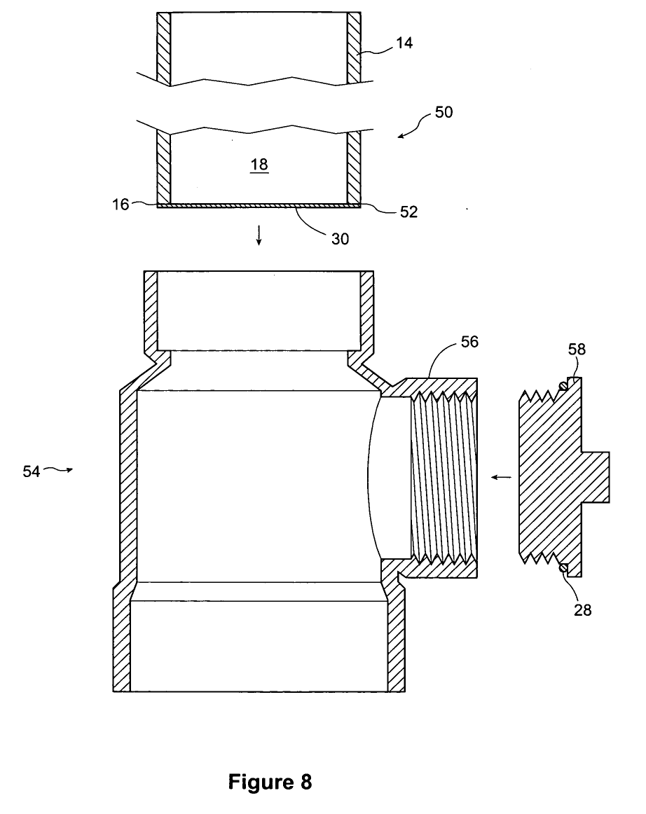

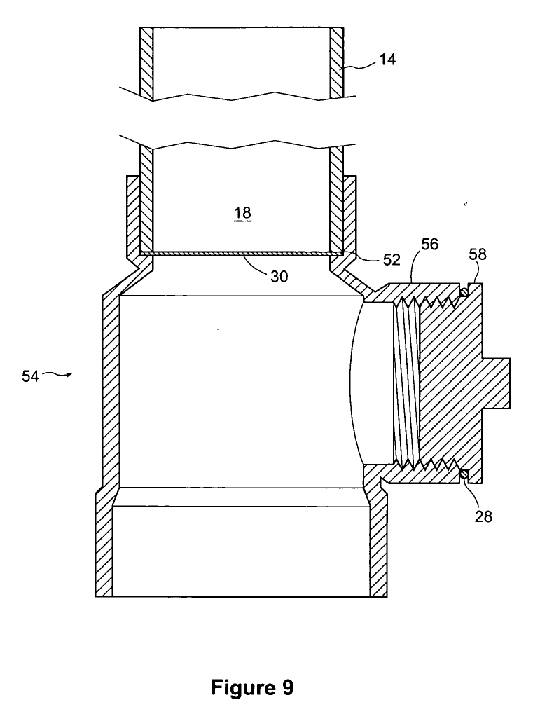

Similarly, as shown in FIG. 7, another embodiment of the present invention is a pipe 50 to which the hydraulic test membrane 30 is bonded across the fluid passageway 18, at the outlet 16. As will be appreciated, such a pipe 50 may be used in association with a conventional tee clean out fitting, as shown in FIGS. 8 and 9. Accordingly, the membrane sealed end 52 of the pipe 50 can be inserted into a regular tee clean out fitting 54, thus sealing the plumbing drainage system just above the access opening 56 of the clean out tee 54. Once the hydraulic testing is successfully completed the plumber punctures the hydraulic test membrane 30 with a knife, for example, through the access opening 56 and allows the test water to controllably drain through a hole in the membrane 30 into the sewer line. With the test water completely drained, the plumber then uses a knife, or the like, to cut out the test membrane 30 from the pipe by severing it entirely about its periphery. The plumber will be able to do so by reaching into the test tee clean out fitting 54 through the access opening 56. The plumber can then remove the cut-out hydraulic test membrane through the access opening 56. Finally, the plumber readies the drainage system for use by securing the cover 58 to the access opening 56. This embodiment is similar to the first embodiment in practical effect, except that instead of being bonded across the shoulders 32 of the tee, the membrane 30 is bonded across the pipe end. This is believed less preferred because the membrane 30 would be more exposed at the end of the pipe 50, and more likely to be damaged in transit from the manufacturing site to the building location. For the purposes of this invention, the term fitting therefore comprehends both a fitting such as a clean out tee or closet flange, but also a pipe end section which is to be inserted into the clean out tee or the like.

While the forgoing has described certain preferred embodiments of the invention, it will be understood that various alterations and modifications are possible without departing from the broad spirit of the invention as defined by the attached claims. Some of these modifications have been discussed above and others will be apparent to those skilled in the art.

I claim:

1. A fitting for a plumbing drainage system, said fitting comprising:
a body;
an inlet at one end of the body;
an outlet at the other end of the body;
a fluid flow passageway extending between the inlet and the outlet through said body; and
a hydraulic test membrane bonded to said fitting across said fluid passageway, said hydraulic test membrane being sized and shaped to be manually punctured.

2. The fitting as claimed in claim 1, wherein said hydraulic test membrane is integrally formed of a uniform thickness.

3. The fitting as claimed in claim 1, wherein said hydraulic test membrane is transparent.

4. The fitting as claimed in claim 1, wherein said hydraulic test membrane is bonded to an inner wall of said fitting.

5. The fitting as claimed in claim 4, wherein said inner wall includes an inwardly directed shoulder between said inlet and said outlet, said shoulder having an upstream face, and wherein said hydraulic test membrane is bonded to said upstream face.

6. The fitting as claimed in claim 5, wherein said upstream face is generally perpendicular to said fluid passageway fitting.

7. The fitting as claimed in claim 5, wherein said hydraulic test membrane is bonded to said upstream face by means of at least one bonding ring sealing said hydraulic test membrane to said upstream face.

8. The fitting as claimed in claim 7, wherein said at least one bonding ring is integral to said upstream face.

9. The fitting as claimed in claim 7, wherein said at least one bonding ring is integral to said hydraulic test membrane.

10. The fitting as claimed in claim 7, wherein said bonding ring is a generally continuous ring member which is bonded to (a) said upstream face, and (b) said hydraulic test membrane about a periphery of said hydraulic test membrane.

11. The fitting as claimed in claim 7, wherein said at least one bonding ring is generally continuous about a periphery of said hydraulic test membrane.

12. The fitting as claimed in claim 7, wherein said hydraulic test membrane is bonded to said upstream face by means of two bonding rings.

13. The fitting as claimed in claim 7, wherein said hydraulic test membrane is flexible, and is held in place by being bonded to said bonding ring.

14. The fitting as claimed in claim 13, wherein said hydraulic test membrane is frangible and can be cut adjacent to said bonded held in place portion.

15. The fitting as claimed in claim 14, wherein said bonded held in place portion cannot be removed from said fitting.

16. The fitting as claimed in claim 1, wherein said hydraulic test membrane is between 0.015 inches and 0.040 inches thick.

17. The fitting as claimed in claim 1, wherein said hydraulic test membrane is 0.020 inches thick.

18. The fitting as claimed in claim 1, wherein said hydraulic test membrane is a metallic foil.

19. The fitting as claimed in claim 18, wherein said metallic foil is between 0.005 inches and 0.020 inches thick.

20. The fitting as claimed in claim 1, wherein said bonded hydraulic test membrane can hold a water pressure head 15 psi.

21. The fitting as claimed in claim 1, wherein said hydraulic test membrane is non self-supporting.

22. The fitting as claimed in claim 1, wherein said hydraulic test membrane is made from a plastic film.

23. The fitting as claimed in claim 22, wherein said plastic is PVC.

24. The fitting as claimed in claim 1, wherein said hydraulic test membrane is sonic welded to said fitting.

25. The fitting as claimed in claim 1, wherein said hydraulic test membrane is unaffected by pipe solvent.

26. The fitting as claimed in claim 1 further comprising:
an access opening on said body to said fluid passageway, said access opening being located between said inlet and said outlet; and
said hydraulic test membrane being manually puncturable from said access opening.

27. The fitting as claimed in claim 26, wherein said hydraulic test membrane is bonded to an inner wall of said fitting, which inner wall includes an inwardly directed shoulder between said inlet and said access opening, said shoulder having an upstream face, and wherein said hydraulic test membrane is bonded to said upstream face.

28. The fitting as claimed in claim 27, wherein said upstream face is generally perpendicular to said fluid passageway fitting.

29. The fitting as claimed in claim 27, wherein said fitting is a test tee clean out fitting.

30. The fitting as claimed in claim 29 further comprising a removable cover to cover said access opening.

31. The fitting as claimed in claim 1, wherein said fitting is a closet flange.

32. The fitting as claimed in claim 1, wherein said fitting is a pipe.

33. A method of making a fitting for a plumbing drainage system comprising the step of bonding a hydraulic test membrane into said fitting to form a watertight load supporting barrier across said fitting before said fitting is sent to a building site.

34. The method of making a fitting as claimed in claim 33, including the step of cutting said hydraulic test membrane to a predetermined size and shape before said hydraulic test membrane is bonded to said fitting.

35. The method of making a fitting as claimed in claim 33, including the step of sonic welding said hydraulic test membrane within said fitting.

36. The method of making a fitting as claimed in claim 35, wherein said method includes the step of bonding said hydraulic test membrane to an inner wall of said fitting.

37. The method of making a fitting as claimed in claim 36, wherein said inner wall includes an inwardly directed shoulder between an inlet and an access opening of said fitting, said shoulder having an upstream face, and said method includes the step of bonding said hydraulic test membrane to said upstream face by means of at least one bonding ring to seal said hydraulic test membrane to said upstream face.

38. The method of making a fitting as claimed in claim 37, wherein said fitting comprises a fluid flow passageway extending between said inlet and said outlet, and said upstream face is generally perpendicular to said fluid flow passage way.

39. The method of making a fitting as claimed in claim 37, wherein said at least one bonding ring is integral to said upstream face.

40. The method of making a fitting as claimed in claim 37, wherein said at least one bonding ring is integral to said hydraulic test membrane.

41. The method of making a fitting as claimed in claim 38, wherein said at least one bonding ring is a generally continuous projection from one of said hydraulic test membrane and said upstream face, and said method includes the step of bonding said plastic projection on to the other of said hydraulic test membrane and said upstream face.

42. The method of making a fitting as claimed in claim 37, said method includes the step of bonding said hydraulic test membrane to said upstream face by means of two bonding rings.

43. The method of making a fitting as claimed in claim 37, wherein said bonding ring is a generally continuous separate ring member, and said method includes the step of bonding said bonding ring to (a) said upstream face, and (b) said hydraulic test membrane about a periphery of said hydraulic test membrane.

44. The method of making a fitting as claimed in claim 33, including the step of forming said membrane from a material which is impervious to pipe solvent.

45. The method of making a fitting as claimed in claim 33, wherein said hydraulic test membrane is between 0.015 inches and 0.040 inches thick.

46. The method of making a fitting as claimed in claim 45, wherein said hydraulic test membrane is 0.020 inches thick.

47. The method of making a fitting as claimed in claim 33, wherein said hydraulic test membrane is a metallic foil.

48. The method of making a fitting as claimed in claim 47, wherein said metallic foil is between 0.005 inches and 0.020 inches thick.

49. The method of making a fitting as claimed in claim 33, wherein said bonded hydraulic test membrane can hold a water pressure head 15 psi.

50. The method of making a fitting as claimed in claim 33, wherein said hydraulic test membrane is non self-supporting.

51. The method of making a fitting as claimed in claim 33, wherein said hydraulic test membrane is made from a plastic film.

52. The method of making a fitting as claimed in claim 51, wherein said plastic is PVC.

53. The method of making a fitting as claimed in claim 33, wherein said fitting is a test tee clean out fitting.

54. The method of making a fitting as claimed in claim 33, wherein said fitting is a closet flange.

55. The fitting as claimed in claim 33, wherein said fitting is a pipe.
